(19) United States
(12) Patent Application Publication
(10) Pub. No.: US 2005/0285948 A1
(43) Pub. Date: Dec. 29, 2005

(54) System and method for processing a digital camera image

(76) Inventor: Harvey Weinberg, Sharon, MA (US)

Correspondence Address: John L. Conway;Bromberg & Sunstein LLP, 125 Summer Street, Boston, MA, 02110-1618, US

(21) Appl. No.: 11/146,923

(22) Filed: Jun. 7, 2005

Related U.S. Application Data
(60) Provisional application No. 60/582,042, filed on Jun. 22, 2004.

(51) Int. Cl. H04N 5/225; H04N 9/04

(52) U.S. Cl. 348/208.99; 348/207.99

(57) ABSTRACT

A system and method for measuring rotational motion of devices such as cameras. A pair of linear accelerometers is attached to a camera. The accelerometers are spaced a fixed distance apart about a rotational axis to form an angular accelerometer. The angular accelerometer is used to measure the rotational acceleration about an axis of interest. The measured angular acceleration is integrated to calculate angular displacement about the axis. The angular displacement may be used to process camera images. For example, a camera image may be corrected for certain movements of the camera, such as rotations about a yaw or pitch axis.

This application claims priority from U.S. provisional patent application No. 60/582,042, filed Jun. 22, 2004, entitled “Method for Image Stabilization for Digital Cameras,” which is incorporated herein by reference.

### TECHNICAL FIELD

The present invention relates to measuring movements of cameras using linear accelerometers and, in particular, to calculating corrections for such movements.

### BACKGROUND

Movement of a digital camera during image exposure results in image smearing across the image sensor. In general, translational camera movement in the X, Y, or Z axes or rotation about the roll axis (front-to-back) does not have as significant an effect on image sharpness as rotation in the yaw or pitch axes. Therefore, a method for improving the sharpness of a camera image taking into account rotation along the yaw or pitch axes is desirable.

### SUMMARY OF THE INVENTION

In a first embodiment of the invention, a pair of linear accelerometers is attached a fixed distance apart on a camera forming an angular accelerometer. Rotational acceleration about an axis between the accelerometers is measured by the accelerometer and then integrated twice to determine rotational displacement about the axis. An image taken by the camera is then processed using the calculated displacement. In some embodiments of the invention, the image is corrected for motion of the camera body, such as a rotation in a yaw or pitch axis. In other embodiments of the invention, a plurality of pairs of accelerometers is provided and rotational displacement about a plurality of axes is determined. In some embodiments of the invention, at least one integrator is provided to facilitate determination of displacement from acceleration.

### BRIEF DESCRIPTION OF THE DRAWINGS

The foregoing features of the invention will be more readily understood by reference to the following detailed description, taken with reference to the accompanying drawings, in which:

FIG. 1 shows the placement of linear accelerometers on a camera body to form angular accelerometers, according to an embodiment of the invention;

FIG. 2 shows a conceptual diagram of a system for measuring angular acceleration about a yaw axis, according to an embodiment of the invention;

FIG. 3 illustrates an angular displacement for the embodiment of FIG. 2; and

FIG. 4 shows placement of an accelerometer pair for an embodiment of the invention which may be employed with devices such as camcorders.

### DETAILED DESCRIPTION OF SPECIFIC EMBODIMENTS

In certain embodiments of the invention, a pair of linear accelerometers is attached to a camera. The accelerometers are spaced a fixed distance apart to form an angular accelerometer. This angular accelerometer can measure the rotational acceleration about an axis of interest. The measured angular acceleration may then be integrated to calculate angular displacement about the axis. This angular displacement may be used to process digital camera images. For example, the images may be corrected for movements of the camera, such as rotations about a yaw or pitch axis.

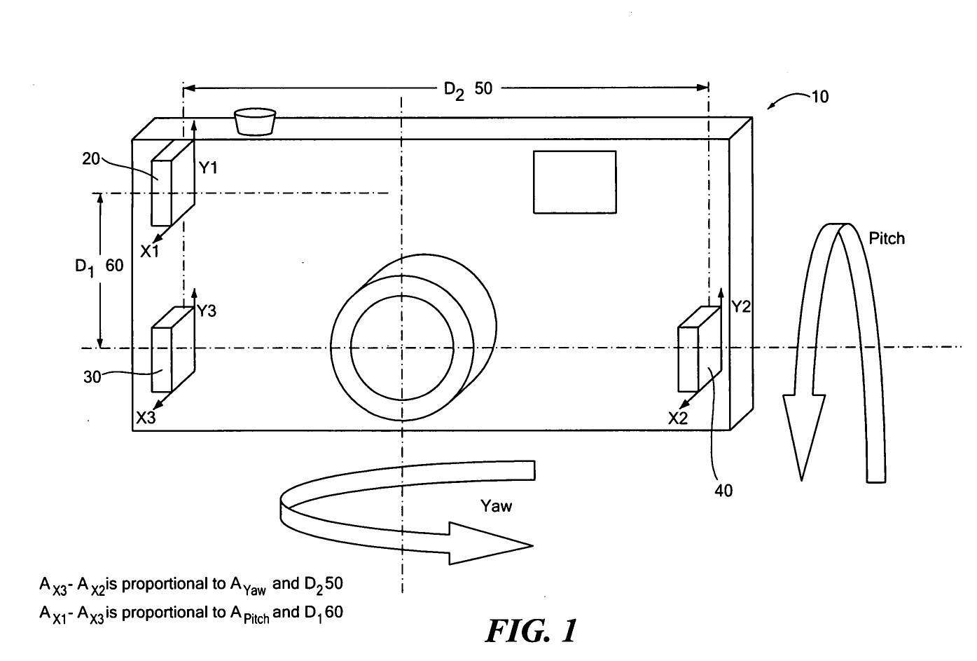

FIG. 1 shows the placement of accelerometers on a digital camera 10 according to an embodiment of the invention. Three single axis accelerometers (20, 30, 40) are placed such that two pairs of accelerometers (20-30 and 30-40) are horizontally opposed on the camera. The acceleration in the yaw axis is proportional to the difference in acceleration in the x direction between one pair of accelerometers (30-40), A_{X3}-A_{X2}, and to the yaw radius, which is half of distance D₂ 50. Similarly, the acceleration in the pitch axis is proportional to the difference in acceleration in the x direction between the other pair of accelerometers (20-30), A_{X1}-A_{X3,} and to the pitch radius, which is half of distance D₁ 60. Linear acceleration, which is common to each pair of accelerometers because they are coupled to the rigid camera body, is rejected.

When rotational acceleration is sensed using the accelerometers, the image sensor may be moved, or the image may be optically steered by an amount proportional to the acceleration to correct for the movement. The magnitude of the rotational acceleration is given by:
rotational acceleration=0.0511*f²*r*Sin(Arctan (image shift/lens focal length)),

where rotational acceleration is in units of g (gravity);

f is in Hz;

r (radius) is in millimeters; and

focal length is in millimeters.

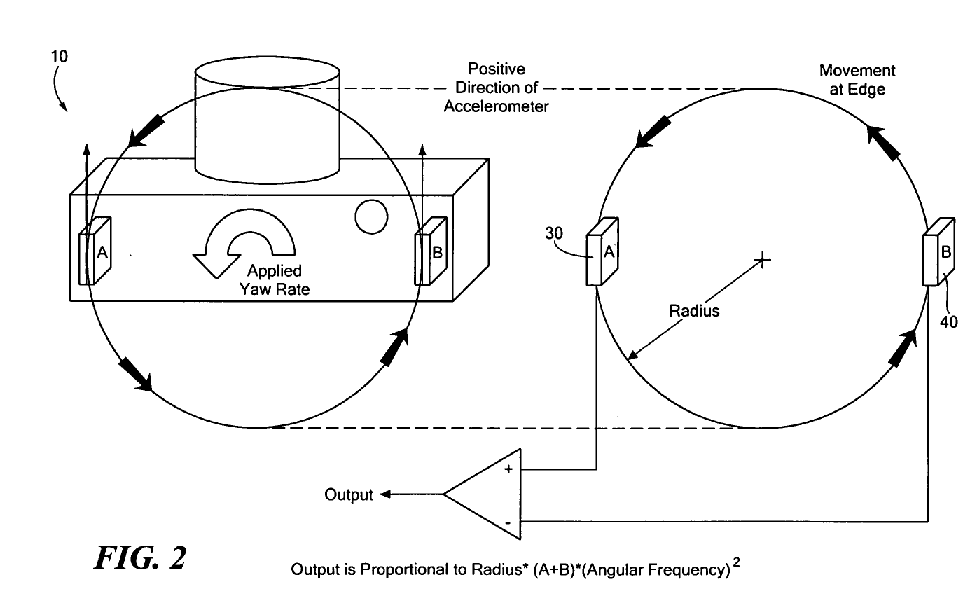

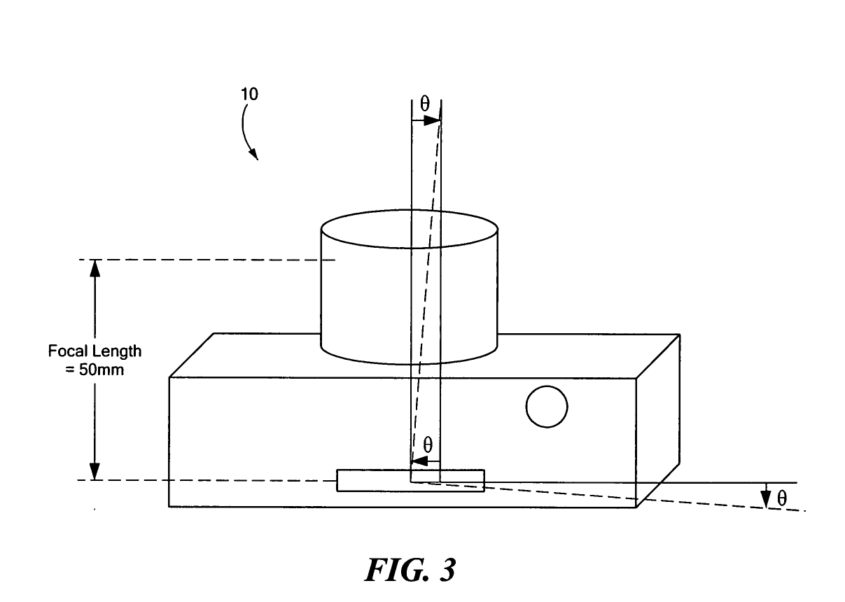

A graphical representation of the geometry for yaw axis sensing, for example, is shown in FIGS. 2 and 3.

For a 4*10⁻⁶ meter pixel size and a one pixel image shift:
θ=Arctan(4*10⁻⁶/50 mm)=0.005°

Displacement (at the accelerometer) at a radius of 50 mm is:
S=0.05*sin θ=4.4*10⁻⁶ meters=0.0002 inch

For a radius of 50 mm (half the distance between the accelerometers) at 10 Hz.:
Rotational acceleration=0.0511*f²*S
where S in inches
=0.9*10⁻³ g at each accelerometer per pixel of image shift.

The pitch axis case is similar, but rotated 90 degrees.

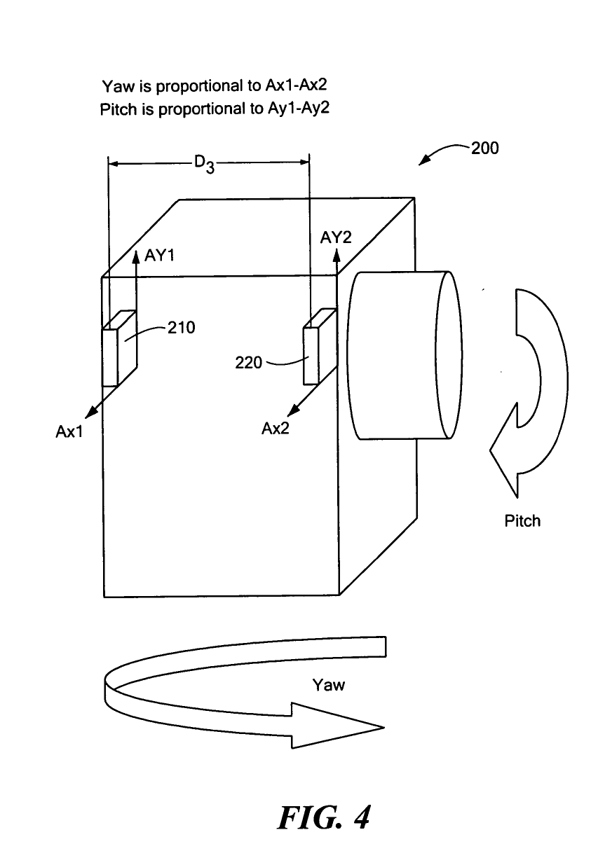

In other embodiments of the invention, a variety of accelerometer placements on the camera body are possible. For example, one sensor 210 may be placed at the back of the camera 200 and another 220 in the front, as shown in FIG. 4. This placement of accelerometers makes sense for devices, such as camcorders, in which the front to back distance is large. The inter-accelerometer distance will be large enough to provide a usable signal for typical displacements. In any case, the same principal of operation holds.

In preferred embodiments of the invention, the distance between accelerometers is made as large as practical to improve the signal-to-noise ratio of the output.

In order to convert angular acceleration to positional information (usable to control the translation of the image sensor or optically steer the image), double integration of the angular acceleration is performed. In preferred embodiments of the invention, at least one integrator, or parts of an integrator, may be incorporated into the angular accelerometer.

For some applications, for example digital video cameras, a very low 1/f noise frequency is preferred. In one embodiment, accelerometers may be used that have very low 1/f noise (1/f frequency corner is under 0.5 Hz).

Logic performing the processing functions may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device.

Other variations and modifications of the embodiments described above are intended to be within the scope of the present invention as defined in the appended claims.

1. A method of processing an image taken by a camera, the method comprising:
a. providing a camera, the camera including a pair of linear accelerometers spaced apart and fixedly attached to the camera to form an angular accelerometer;
b. measuring rotational acceleration of the camera about an axis using the angular accelerometer; and
c. processing the image using the measure of rotational acceleration about the axis.

2. A method according to claim 1 wherein processing the image includes correcting the image for a rotation of the camera about the axis.

3. A method according to claim 1 wherein measuring rotational acceleration includes measuring the acceleration about a plurality of axes.

4. A method according to claim 3 wherein processing the image includes correcting the image for a rotation of the camera about a plurality of axes.

5. A method according to claim 1 wherein at least one accelerometer has a 1/f frequency corner under 0.5 Hz.

6. A method according to claim 1 wherein the spacing between the pair of accelerometers is at least 90% of the camera dimension along a line through the pair of accelerometers.

7. A method according to claim 1 wherein the camera further includes at least one integrator to transform the output of the pair of accelerometers to a rotational displacement.

8. A system for processing an image taken by a camera, the system including:
a. the camera;
b. a pair of linear accelerometers fixedly attached to the camera and spaced a distance apart about an axis of rotation;
c. logic for processing the output of the pair of accelerometers to measure angular acceleration about the axis; and
d. logic for processing the image taken by the camera using the measure of angular acceleration.

9. A system according to claim 8 wherein processing the image includes correcting the image for a rotation of the camera about an axis.

10. A system according to claim 8 wherein logic for processing the output of the pair of accelerometers further includes logic for calculating the acceleration about a plurality of axes.

11. A system according to claim 8 wherein the accelerometers have a 1/f frequency corner under 0.5 Hz.

12. A system according to claim 8 wherein the spacing between the pair of accelerometers is at least 90% of the length of the camera along a line through the accelerometers.

13. A system according to claim 8 wherein the camera further includes at least one integrator to transform the output of the accelerometers to a rotational displacement.
